(19) United States
(12) Patent Application Publication
(10) Pub. No.: US 2008/0156539 A1
(43) Pub. Date: Jul. 3, 2008

(54) Non-rotating drill system and method

(76) Inventor: Mark R. Ziegenfuss, Ringoes, NJ (US)

Correspondence Address: Kenneth P. Glynn, 24 Mine Street, Flemington, NJ, 08822, US

(21) Appl. No.: 11/646,949

(22) Filed: Dec. 28, 2006

(51) Int. Cl. E21B 4/14; E21B 10/36; G06G 7/48

(52) U.S. Cl. 175/296; 175/420.1; 703/10

(57) ABSTRACT

A pneumatically operated, deep hole rock drilling system for non-rotating drilling includes a pneumatically operated drive, a hammer sleeve with hammer mechanisms therein/connected thereto, a hammer bit below the hammer sleeve and a tube string above the hammer sleeve. The pneumatically operated drive includes a pneumatic pressure delivery mechanism and a drive piston. Further, this drive means has air flow channel means for delivery of air to the drive piston for reciprocally driving a hammer bit. The hammer bit has a convex bottom and a sidewall. The convex bottom has a plurality of impact buttons. The convex bottom has a center, with the sidewall being a predetermined distance X from the center. The hammer bit has a plurality of sidewall impact buttons located on the sidewall, the sidewall buttons being arranged at a plurality of different distances from the bottom and having sufficient sidewall impact buttons to create a solid effective perimeter from a bottom footprint view to create a minimum distance of at least X plus Y from the center at all points along the perimeter, wherein Y is at least 20% of a length of a sidewall button.

### BACKGROUND OF INVENTION

a. Field of Invention

The invention relates generally to deep hole rock drilling apparatus for deep wells, oil and gas exploration and the like. More specifically it relates to unconventional deep hole rock drilling without rotation of the bit, and to specific hammer bit configurations for reciprocally impacted non-rotating drilling therewith. These present invention bits having impact crushing buttons on both the bottom and the sides of the bit with side exit paths for mud, dirt and crushed rock movement from the impacting area underneath the bit.

b. Description of Related Art

The following patents are representative of various types of drilling apparatuses, some for deep hole rock drilling and others for short well soil drilling:

U.S. Pat. No. 3,640,351 to Merton W. Coyne describes a member comprising the shank or an integral shank drill rod for a percussion rock drill and having a force-deflection or stiffness characteristic similar to the effective stiffness of the earth formation to be penetrated. The member is adapted to be removably inserted to the rock drill in blow-receiving relationship with a reciprocating hammer element. The member is also operable to be a rotating-transmitting means for rotating an extension drill string.

U.S. Pat. No. 3,911,789 to John V. Bouyoucos describes hydraulic impact tools that develop percussive forces for rock drilling and other repetitive high force applications. A self-excited oscillator is disclosed which includes a hammer and a valve coaxial with and actuated by the hammer for controlling the flow of pressurized hydraulic fluid. The hammer is accelerated away from the impact position to store energy in an energy storage system. The stored energy in the system is eventually returned to the hammer to drive it at increasing velocity back to its impact position. Accumulators forming part of the oscillator are closely coupled to the hammer by way of hydraulic galleries or channels and operate in concert with the hammer to provide energy storage characteristics for oscillator operation and to reduce fluctuations in the flow of hydraulic fluid and to provide for efficient operation of the oscillator.

U.S. Pat. No. 4,062,411 to Richard W. Adkins describes a hydraulic percussion tool for developing repeated impact blows for rock drilling and other high force applications is characterized by a piston hammer reciprocally disposed in a cylinder bore and a tubular valve member coaxial with and actuated by the hammer for controlling the flow of pressurized hydraulic fluid to and from portions of the cylinder bore. The valve member is actuated by the hammer on the return stroke thereof through a column of fluid trapped in an annular chamber between a transverse surface on the hammer and an end face of the valve member. Valving mechanism is operable to effect controlled venting of the trapped fluid from the annular chamber to change the position of the valve member with respect to the hammer and thereby control the hammer stroke length, impact blow, and blow frequency.

U.S. Pat. No. 4,077,304 to Bouyoucos describes impact tools that are capable of developing percussive forces for rock drilling, seismic exploration and other repetitive high force applications. Each of the tools contains a hammer and a valve which may be hydraulically actuated so as to constitute a hydroacoustic oscillator. The valve is actuated in one direction by being engaged by the hammer and in the other direction by fluid pressure means. The fluid pressure means may be controlled by varying the fluid pressure magnitude which applies forces to the valve to effect the movement thereof so as to control the frequency of oscillation of the hammer (i.e., impact blow frequency). Control may also be provided over the hammer stroke and the blow energy.

U.S. Pat. No. 4,143,585 to Roger L. Selsam describes an impact tool which is capable of developing percussive forces for rock drilling, pile driving, seismic exploration and other repetitive high force applications. The tool contains a hammer and a valve which may be hydraulically actuated so as to oscillate; repetitively executing forward and return strokes during each cycle of oscillation. The valve is actuated in the forward stroke direction by being engaged by the hammer, and in the return stroke direction by fluid pressure means so as to switch the pressure in a cavity in which both the valve and the hammer are disposed for developing forces on the hammer so as to sustain its oscillation. A fluid filled pocket is provided into which the valve enters as it moves in the forward stroke direction, after having switched the pressure in the cavity. A passage is provided on the hammer which dimensioned so that fluid in the cavity is either connected to a channel, the cavity, or entrapped in the pocket, depending on the position of the hammer. A control valve in the channel determines the flow through the channel, and thus the displacement of the valve into the pocket. The displacement is maintained until communication between the pocket and the cavity is provided via the passage. Control is thereby provided over the stroke of the valve and the period between switching of the pressure in the cavity. The hammer stroke length and the frequency and energy of the impacts delivered by the hammer are dependent upon the switching period, and may be varied by the use of the control valve.

U.S. Pat. No. 4,747,455 to Cunningham describes a high impact device, as for producing an impact of 1,000 foot pounds or more, including a ram which is engageable by a pair of rotating flywheels. The ram may impact a tool, as of a chisel type adapted for demolition purposes, or having a enlarged head for percussion purposes, or other types or purposes. By terminating the engagement of the flywheels with the ram prior to its impact against a tool or similar object, the vibration normally associated with a demolition or percussion device is avoided. Such termination of engagement also reduces reverse shocks and conserves the energy of the rotating flywheels. In one embodiment, the flywheels are moved inwardly and outwardly of the ram through a linkage connected to a solenoid, with each flywheel supported between a pair of arms and alignment of the axis of each flywheel with the side of the corresponding ram being maintained by a torque tube extending between the arms. A guide for the ram extends into a tool housing, and the ram has an enlargement to engage a hole in an upper plate to limit upward movement and on downward movement to engage a metal ring placed above a pair of resilient rings, for resiliently terminating downward movement of the ram, if necessary. In another embodiment, one flywheel is fixed, although adjustable laterally, while the other flywheel is pivotally mounted and moved by a hydraulic cylinder with each flywheel being rotated by a hydraulic motor. A heavy coil spring is engaged by the ram on its upward stroke and returns the energy, normally dissipated, to the ram to start it down so that the ram is moving downwardly when engaged by the flywheels. A sensor activated on the upward stroke of the ram may control the inward movement of the movable flywheel while a sensor activated on the downward stroke of the ram may control the withdrawal of the movable flywheel from the ram path. Each sensor control is correlated with the lag time in the movement of the ram from the activating position to a position at which the flywheels should engage the ram and a position when the upper end of the ram is just below the flywheels, respectively.

U.S. Pat. No. 5,186,268 to John M. Clegg describes a rotary drill bit body carrying a plurality of primary preform cutting elements defining a primary cutting profile. The bit includes means to apply a lateral imbalance force to the bit as it rotates, and a portion of the outer periphery of the bit body includes a low friction bearing surface so located as to transmit the lateral force to the formation. There are associated with some of the primary cutting elements respective secondary elements spaced inwardly of the cutting profile defined by the primary cutting elements, but the portion of the periphery of the bit body where the bearing surface is located is substantially free of such secondary elements. The arrangement enhances the antiwhirl characteristics of the bit.

U.S. Pat. No. 5,238,075 to Carl W. Keith describes a fixed cutter drill bit that includes a plurality of angularity spaced radial wings each with a row of cutting elements mounted thereon and protruding from the bit for drilling through formation material. On a first of the wings, a first row of the cutting elements has alternately larger and smaller area cutting faces at spaced selected radial positions relative to the center of the bit. Similarly, a second row of cutting elements is mounted on a second of the wings at substantially the same radial positions but with radial positions of the lager and smaller cutting faces reversed over those on the first wing. A third wing includes a third row of cutting elements with cutting faces of intermediate area located at each of the selected radial positions. The combination of different sizes of cutting elements at each radial position defines a set having a profile with the intermediate and smaller cutting elements located entirely within the larger cutting element. The profiles of the larger cutting elements of adjacent sets overlap each other without substantial overlapping of the profiles of any of the other cutting elements.

U.S. Pat. No. 5,265,685 to Carl W. Keith describes a fixed cutting element drill bit is provided with primary cutting elements which are spaced radially from each other across the face of the bit. During drilling, the gap between the cutting elements causes a ridge to be formed in the bottom of the well and the apex of the ridge is removed before reaching the face of the bit. In one form of the invention, the apex is broken off by utilization of the sides of the supports for the primary cutting elements.

U.S. Pat. No. 5,435,402 to Mark Ziegenfuss describes a self-propelled hammer-bit assembly for pneumatically drilling a borehole in the earth. It includes a hammer-bit member having an elongated main body with a hollow area therein and at least one blade located in the hollow area. The blade(s) is adapted to receive pressurized air to impart a rotation to the hammer-bit member which has a bit located at its distal end. The bit has at least one orifice to permit exit of pressurized air from the hollow area. For lateral stabilization with free rotation of the hammer-bit member, a bearing collar is connected to its elongated main body. There is also a distal barrel with the bearing collar connected thereto and the hammer-bit member located in the barrel collar. Finally, a reciprocation mechanism is located within the barrel and connected to the hammer-bit member to impart vertical reciprocation of the hammer-bit member in response to pressurized air. The invention also includes the hammer-bit member itself.

U.S. Pat. No. 6,439,318 B1 to Alan Martyn Eddison describes a downhole drilling assembly having a body for mounting on a drillstring, the body defining a fluid conduit. A drilling fluid driven motor is mounted in the body and is coupled to a flow restricting device axially movably mounted to the body. The device is coupled to a drill bit. In use, the flow restricting device is driven by the motor to vary the flow of drilling fluid through the body and produce a varying fluid pressure force to induce axial movement of the device relative to the body, and thus provide a percussive or hammer drilling effect. The flow restricting device may be coupled to the drill bit by a mandrel splined or otherwise coupled to the body. Alternatively, the flow restricting device may be coupled to the drill bit by a rotatable shaft such that the motor mat also rotate the drill bit.

Notwithstanding the prior art, the present invention is neither taught nor rendered obvious thereby.

### SUMMARY OF INVENTION

The invention solves the problems and overcomes the drawbacks and deficiencies of prior art by providing hammer bits, systems and methods for deep hole rock drilling without the need for a turning motor. This decreases assembly and disassembly time and labor costs, as well as equipment costs. It also reduces the wear and tear-on some of the equipment resulting from the elimination of rotation. The present invention can thus be used in drilling without rotation motors, or, alternatively, with drilling motors, in drilling where rotation is turned off at depths or formations where it is advantageous to do so. In other words, in some embodiments, it is a totally non-rotational system, while in other embodiments, it is a system that includes both non-rotating and rotating options.

The present invention system is a pneumatically operated, deep hole rock drilling system for non-rotating drilling that includes pneumatically operated drive means, a hammer sleeve with manner mechanisms therein/connected thereto, a hammer bit below the hammer sleeve and a tube string above the hammer sleeve. The pneumatically operated drive means includes a pneumatic pressure delivery mechanism and a drive piston. Further, this drive means has air flow channel means for delivery of air to the drive piston for reciprocally driving a hammer bit. The hammer sleeve has a proximal end and a distal end, the hammer sleeve is connected to the drive means and contains the drive piston. The tube string has a plurality of interconnected drill tubes, the tube string having a proximal end, being a top end, and having a distal end, being a bottom end. The distal end of the string is connected to the proximal end of the hammer sleeve, and the pneumatic pressure delivery mechanism is connected to the proximal end of the string. The hammer bit has a convex bottom and a sidewall. The convex bottom has a plurality of impact buttons. Also, the convex bottom has a center, with the sidewall being a predetermined distance X from the center. The hammer bit has a plurality of sidewall impact buttons located on the sidewall, the sidewall buttons being arranged at a plurality of different distances from the bottom and having sufficient sidewall impact buttons to create a solid effective perimeter from a bottom footprint view to create a minimum distance of at least X plus Y from the center at all points along the perimeter, wherein Y is at least 20% of a length of a sidewall button. The hammer bit is connected to the distal end of the hammer sleeve.

In some preferred embodiments of the present invention, the hammer bit includes at least one air return orifice. In some of these preferred embodiments of the present invention, at least one air return orifice is connected to an outwardly extending channel cut into the convex bottom of the hammer bit.

In some preferred embodiments of the present invention, the sidewall impact buttons are arranged in at least two off-set circumferential rows. In some preferred embodiments of the present invention, the impact buttons have a bullet shape with a circular topography having a diameter of about ⅜ inch to about 1 inch and having a height of about ½ inch to about 1¼ inch. In some preferred embodiments of the present invention, the impact buttons are removably inserted into the hammer bit to be individually replaceable.

In some preferred embodiments of the present invention, the pneumatically operated drive means includes a backhead member connected to the proximal end of the hammer sleeve, an air check valve, an air diverter, an air control tube, and the piston. The hammer bit may preferably be connected to the hammer sleeve with a bit chuck and retainer.

In some preferred embodiments of the present invention, the hammer bit includes a plurality of air return orifices and an outwardly extending channel cut into the convex bottom of the hammer bit from each of the plurality of air return orifices to the sidewall.

The present invention further includes a pneumatically operated, deep hole rock drilling method for non-rotating drilling. It includes providing an apparatus that includes the system described above, with a high pressure air compressor connected to the pneumatically operated drive means; and pneumatically driving the apparatus into a hard rock surface by non-rotating reciprocal drilling.

The present invention also includes a single device, that is, the hammer bit described above as a single entity product.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 is a front sectional view of an embodiment of a non-rotating, deep hole rock drilling system according to the present invention;

FIG. 2 is an exploded view of the hammer and hammer bit of system sown in FIG. 1;

FIG. 3 is an enlarged partial side sectional view of a portion of a present invention hammer bit;

FIG. 4 is a bottom view and FIG. 5 is a side cut view of another present invention hammer bit;

FIG. 6 is a bottom peripheral illustration view of the present invention hammer bit of FIG. 4 and FIG. 7 illustrates a partial top sectional view of some of the impact buttons of the FIGS. 4 through 6 present invention hammer bit;

FIG. 8 is a bottom view of another present invention hammer bit; and,

FIGS. 9 and 10 are front views of alternative impact buttons for present invention hammer bits.

### DETAILED DESCRIPTION OF THE EMBODIMENTS

The present invention relates generally to deep hole rock drilling apparatus wherein it is necessary to use significant drilling and impact force to break up hard rock and to do it at deep depths, such as hundreds of feet or more below the surface. Thus, the present invention drill bit, system and method are for deep hole, hard rock drilling, such as deep wells, oil and gas exploration and the like. More specifically, the invention relates to unconventional deep hole rock drilling without rotation of the bit by a motor. This creates significant savings as it negates the costs and efforts of using a rotation drive motor in the deep well efforts. The invention also pertains to specific hammer bit configurations for reciprocally impacted non-rotating drilling therewith. These present invention bits have impact crushing buttons on both the bottom and the sides of the bit with side exit paths for mud, dirt and crushed rock movement from the impacting area underneath the bit.

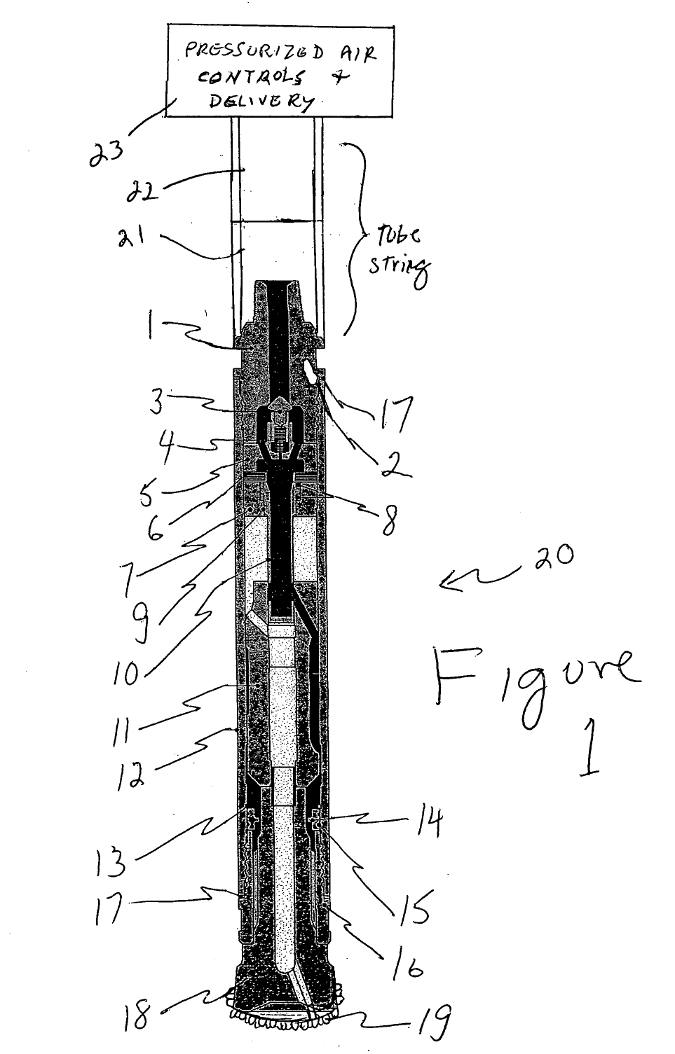

Referring now to the drawings, like reference numerals designate corresponding parts throughout the several views of each embodiment where more than one view is presented. FIG. 1 is a front sectional view of an embodiment of a present invention non-rotating, deep hole rock drilling system 20. It includes a backhead member 1, backhead ‘O’ ring 2, check valve 3, with check valve spring 4, diverter 5, compression buffer 6, tube holder 7, buffers 8, tube ‘O’ ring 9 and control tube 10. It also includes piston 11, hammer sleeve 12, piston retaining ring 13, retainer 14, retainer ‘O’ ring 15, chuck 16, breakout washer 17, hammer bit 18 and impact buttons, such as button 19. These components generally show some of the details that may be included but the specifics of the seals, rings and retainers and the like are well within the skills of the artisan and the invention should not be limited to these details set forth in the Figures. System 20 also includes a plurality of interconnected drill tubes such as tubes 21, 22 to create a string, Air controls and pressurized air (compressed air) delivery mechanism 24, including a compressor and other conventional pneumatic drive components.

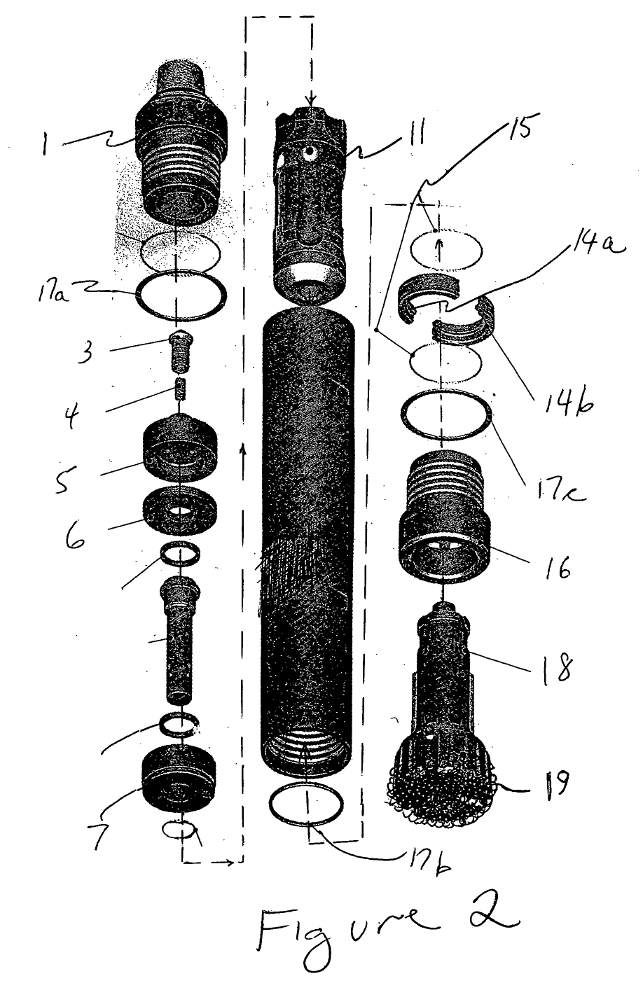

FIG. 2 is an exploded view of the hammer and hammer bit of system 20 shown in FIG. 1. The components are identically numbered and this Figure presents assemblage lines and clearer component views due to the exploded presentation. The buttons require at least two staggered rows around the sidewall and this will be clear from the technical description that follows.

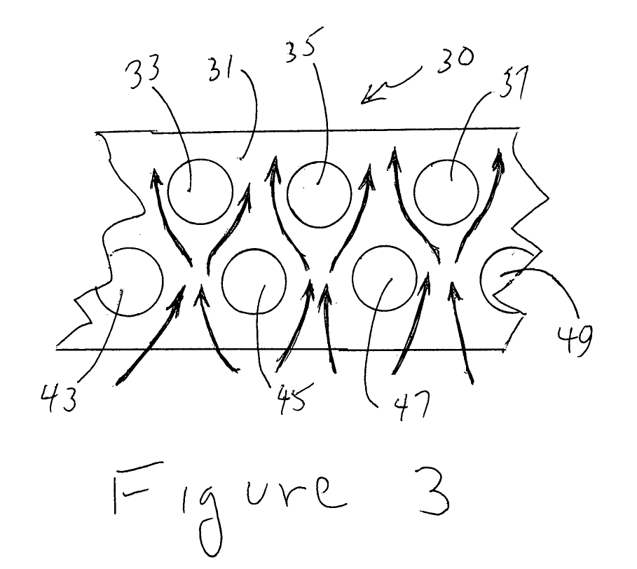

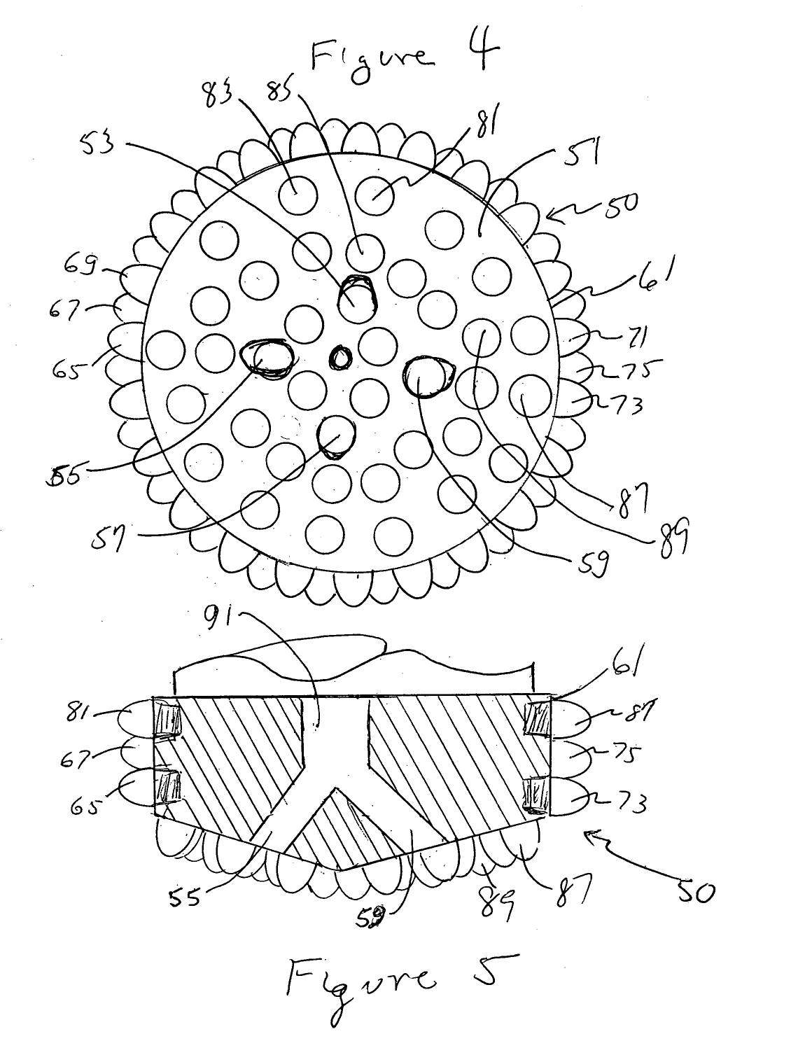

FIG. 3 is an enlarged partial side sectional view of a portion of a present invention hammer bit 30. Hammer bit 30 has sidewall 31 shown partially cut and without its convex bottom. There are two staggered rows of impact buttons, as shown. These are top row impact buttons 33, 35 and 37 and bottom row impact buttons 43, 45 and 47 and they establish a pattern to both permit air and crushed rock and earth movement, as shown by the arrows in the Figure, and create a cut pattern as established by and as shown in FIG. 6, discussed below.

FIG. 4 is a bottom view and FIG. 5 is a side cut view of another present invention hammer bit 50. Both Figures are taken together. It has a convex bottom 51 with air exit orifices 53, 55, 57 and 59. A main air release 91 is a main exhaust from the pressurized air delivery system. Hammer bit 50 has a sidewall 61 with three off-set rows of impact buttons, such as buttons 65, 67, 69, 71, 73, 75. Bottom 101 has a significant number of impact buttons that are exemplified by bottom impact buttons 83, 85, 87 and 89. The impact buttons are usually force fitted into their holes, but may otherwise be affixed, such as by threading.

FIG. 6 is a bottom peripheral illustration view of the present invention hammer bit of the hammer bit 50 of the present invention embodiment described above with respect to FIGS. 4 and 5. In this bottom view “looking up at hammer bit 50 to see its foot print” wherein the outer edge foot print has a plurality of rounded impact buttons that are staggered from a side view and appear to over lap from the bottom view of this FIG. 6. Thus, bottom 51 of hammer bit 50 has a central axis C. The radius if the bit excluding the side wall impact buttons has a radius of X and the apart minimum radius is the hammer bit 50 including the side wall impact buttons it X+Y, wherein Y equals the additional apparent radius and Y is at least 20% of the length of a side wall impact button the side wall buttons suck as buttons 71, 73, and 75 are shown in all of the FIGS. 4, 5, 6, and 7.

FIG. 7 shows a top view of impact buttons 71, 73 and 75 showing the full length “h” of the impact button and the overlap length “y”, with “y” being at least 20% of “h”. In this particular example “y” is about 80% of “h”. Without the overlap in the footprint of the sidewall impact buttons, rock and earth wall segments would not break up and move as readily. Thus, the creation of the increased footprint of X and Y in FIG. 6 is an essential feature of the present invention.

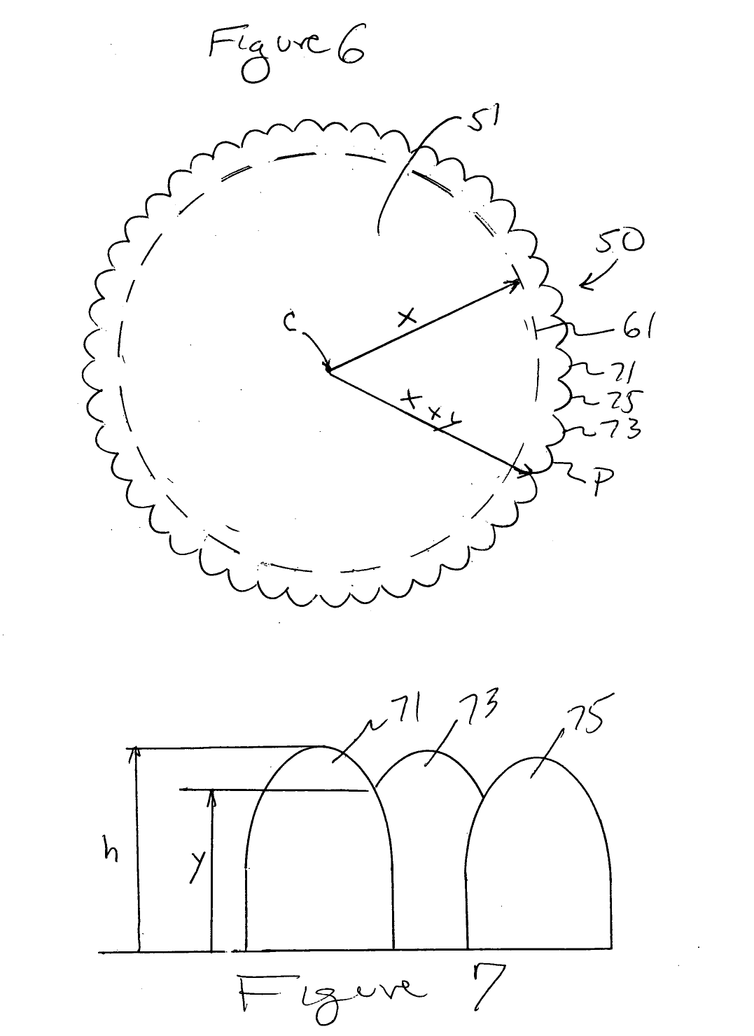

FIG. 8 shows a bottom view of another present invention hammer bit 100 with a bottom 101 and many bottom impact buttons such as impact buttons 103 and 105. There are two staggered rows of sidewall impact buttons and they include buttons 107 and 109. Air exit orifices or exit ports such as ports 111 and 113 are connected to grooved channels such as channels 115 and 117, to enhance movement of air, fluids and solids. This hammer bit 100 may be used in a manner similar to hammer bit 18 described in earlier Figures. A loosely fitted spline will permit natural movement of the hammer bit ib a reciprocal fashion (arcuate movement).

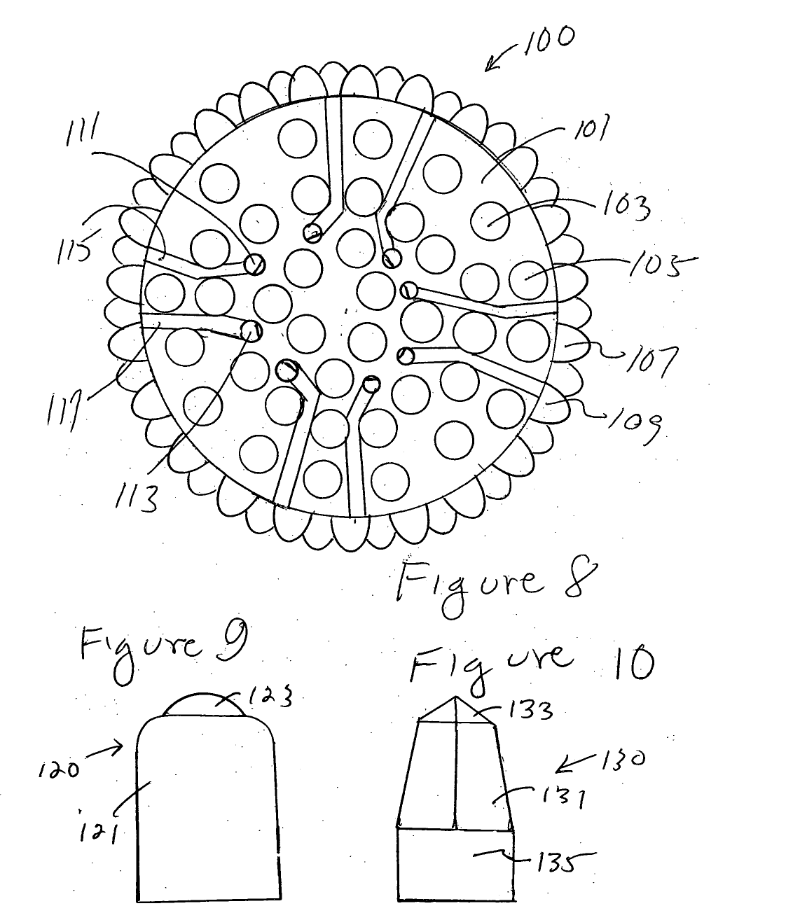

FIGS. 9 and 10 are front views of alternative impact buttons for present invention hammer bits. More specifically, FIG. 9 shows a side view of impact button 120 that has a tapered, chiseled dome 123 and a main cylinder section 121. FIG. 10 shows impact button 130 with a pyramidal dome 133, monolithic walls 131 and cylindrical base 135. Each of these are force fitted into properly positioned orifices located at the bottom and sides of a hammer bit as of shown above.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims. For example, the hammer bits are shown in the above drawings as having vertical spline connections. In the alternative, loose vertical splines or angled splines (non-vertical) could be used to permit natural arcuate reciprocal movement of the hammer bit, or the splines could be eliminated completely to permit natural rotational movement.

What is claimed is:

1. A pneumatically operated, deep hole rock drilling system for non-rotating drilling to drift a complete circular hole without driven rotation, which comprises:
a) pneumatically operated drive means, including a pneumatic pressure delivery mechanism and a drive piston, and said drive means having air flow channel means for delivery of air to said drive piston for reciprocally driving a hammer bit;
b) a hammer sleeve having a proximal end and a distal end, said hammer sleeve being connected to said drive means and containing said drive piston;
c) a tube string having a plurality of interconnected drill tubes, said tube string having a proximal end, being a top end, and having a distal end, being a bottom end, wherein said distal end of said string is connected to said proximal end of said hammer sleeve, and wherein said pneumatic pressure delivery mechanism is connected to said proximal end of said string;
d) a hammer bit having a convex bottom and a sidewall, said convex bottom having air release ports, said convex bottom having a plurality of impact buttons, said convex bottom having a center, said sidewall being a predetermined distance X from said center, said bit having a plurality of sidewall impact buttons located on said sidewall, said sidewall buttons being arranged at a plurality of different distances from said bottom and having sufficient sidewall impact buttons to create a solid effective perimeter from a bottom footprint view to create a minimum distance of at least X plus Y from said center at all points along said perimeter, wherein Y is at least 20% of a length of a sidewall button, said hammer bit being connected to said distal end of said hammer sleeve.

2. The pneumatically operated, deep hole rock drilling system of claim 1 wherein said hammer bit includes at least one air return orifice.

3. The pneumatically operated, deep hole rock drilling system of claim 2 wherein said at least one air return orifice is connected to an outwardly extending channel cut into said convex bottom of said hammer bit.

4. The pneumatically operated, deep hole rock drilling system of claim 1 wherein said sidewall impact buttons are arranged in at least two off-set circumferential rows.

5. The pneumatically operated, deep hole rock drilling system of claim 1 wherein said pneumatically operated drive means includes a backhead member connected to said proximal end of said hammer sleeve, an air check valve, an air diverter, an air control tube, and said piston.

6. The pneumatically operated, deep hole rock drilling system of claim 1 wherein said hammer bit is connected to said hammer sleeve with a bit chuck and retainer.

7. The pneumatically operated, deep hole rock drilling system of claim 1 wherein said hammer bit includes a plurality of air return orifices and an outwardly extending channel cut into said convex bottom of said hammer bit from each of said plurality of air return orifices to said sidewall.

8. The pneumatically operated, deep hole rock drilling system of claim 1 wherein said impact buttons have a bullet shape with a circular topography having a diameter of about ⅜ inch to about 1 inch and having a height of about ½ inch to about 1¼ inches.

9. The pneumatically operated, deep hole rock drilling system of claim 1 wherein said impact buttons are removably inserted into said hammer bit to be individually replaceable.

10. A pneumatically operated, deep hole rock drilling method for non-rotating drilling to drift complete circular hole without driven rotation, which comprises:
A.) providing an apparatus that includes:
a) pneumatically operated drive means, including a pneumatic pressure delivery mechanism and a drive piston, and said drive means having air flow channel means for delivery of air to said drive piston for reciprocally driving a hammer bit;
b) a hammer sleeve having a proximal end and a distal end, said hammer sleeve being connected to said drive means and containing said drive piston;
c) a tube string having a plurality of interconnected drill tubes, said tube string having a proximal end, being a top end, and having a distal end, being a bottom end, wherein said proximal end of said string is connected to said distal end of said hammer sleeve, and wherein said pneumatic pressure delivery mechanism is connected to said proximal end of said string;
d) a hammer bit having a convex bottom and a sidewall, said convex bottom having air release ports, said convex bottom having a plurality of impact buttons, said convex bottom having a center, said sidewall being a predetermined distance X from said center, said bit having a plurality of sidewall impact buttons located on said sidewall, said sidewall buttons being arranged at a plurality of different distances from said bottom and having sufficient sidewall impact buttons to create a solid effective perimeter from a bottom footprint view to create a minimum distance of at least X plus Y from said center at all points along said perimeter, wherein Y is at least 20% of a length of a sidewall button, said hammer bit being connected to said distal end of said hammer sleeve; and,
e) a high pressure air compressor connected to said pneumatically operated drive means; and,
B.) pneumatically driving said apparatus into a hard rock surface by non-rotating reciprocal drilling.

11. The pneumatically operated, deep hole rock drilling method of claim 10 wherein said sidewall impact buttons are arranged in at least two off-set circumferential rows.

12. The pneumatically operated, deep hole rock drilling method of claim 10 wherein said pneumatically operated drive means includes a backhead member connected to said proximal end of said hammer sleeve, an air check valve, an air diverter, an air control tube, and said piston.

13. The pneumatically operated, deep hole rock drilling method of claim 10 wherein said hammer bit is connected to said hammer sleeve with a bit chuck and retainer.

14. The pneumatically operated, deep hole rock drilling method of claim 10 wherein said hammer bit includes a plurality of air return orifices and an outwardly extending channel cut into said convex bottom of said hammer bit from each of said plurality of air return orifices to said sidewall.

15. The pneumatically operated, deep hole rock drilling method of claim 10 wherein said impact buttons have a bullet shape with a circular topography having a diameter of about ⅜ inch to about 1 inch and having a height of about ½ inch to about 1¼ inches.

16. The pneumatically operated, deep hole rock drilling method of claim 10 wherein said impact buttons are removably inserted into said hammer bit to be individually replaceable.

17. A hammer bit for attachment to a hammer for pneumatically operated, nonrotating, deep hole rock drilling to drift complete circular hole without driven rotation, which comprises:
a hammer bit having a convex bottom and a sidewall, said convex bottom having air release ports, said convex bottom having a plurality of impact buttons, said convex bottom having a center, said sidewall being a predetermined distance X from said center, said bit having a plurality of sidewall impact buttons located on said sidewall, said sidewall buttons being arranged at a plurality of different distances from said bottom and having sufficient sidewall impact buttons to create a solid effective perimeter from a bottom footprint view to create a minimum distance of at least X plus Y from said center at all points along said perimeter, wherein Y is at least 20% of a length of a sidewall button, said hammer bit being connected to said distal end of said hammer sleeve

18. The hammer bit of claim 17 wherein said sidewall impact buttons are arranged in at least two off-set circumferential rows.

19. The pneumatically operated, deep hole rock drilling method of claim 17 wherein said hammer bit includes a plurality of air return orifices and an outwardly extending channel cut into said convex bottom of said hammer bit from each of said plurality of air return orifices to said sidewall.

20. The pneumatically operated, deep hole rock drilling method of claim 17 wherein said impact buttons have a bullet shape with a circular topography having a diameter of about ⅜ inch to about 1 inch and having a height of about 1 inch to about 1¼ inches.

21. The pneumatically operated, deep hole rock drilling method of claim 17 wherein said impact buttons are removably inserted into said hammer bit to be individually replaceable. sidewall impact buttons are arranged in at least two off-set circumferential rows.
